(19) United States
(12) Patent Application Publication
(10) Pub. No.: US 2007/0165847 A1
(43) Pub. Date: Jul. 19, 2007

(54) Defined-distribution pseudo-random number generator

(76) Inventors: Jerry Joe Langin-Hooper, Colorado Springs, CO (US); Kanan Joseph Langin-Hooper, Colorado Springs, CO (US)

Correspondence Address: LINDA FLEWELLEN GOULD, 1665 BRIARGATE BLVD. #101, COLORADO SPRINGS, CO, 80920, US

(21) Appl. No.: 11/334,117

(22) Filed: Jan. 18, 2006

(51) Int. Cl. H04L 9/00

(52) U.S. Cl. 380/46

(57) ABSTRACT

The present invention provides a method and an apparatus for generating sequences of pseudo-random numbers. Seed random sequences are used to establish independent pseudo-random sub-processes. Those independent pseudo-random sub-processes are combined through a technique of successive interaction to create final pseudo-random sequences. One set of pseudo-random sub-processes is used to continually reorder a table of potential output values. The table can contain uniformly distributed values or may contain values distributed in a non-uniform manner. A second set of pseudo-random sub-processes is used to select a sequence of output values from the table. The invention creates final pseudo-random sequences of output values that can be equidistributed over large samples or final pseudo-random sequences of output values that have non-uniform distributions.

### BACKGROUND OF THE INVENTION

1. Field of the Invention

The present invention relates generally to a method of and apparatus for generating pseudo-random numbers.

2. Description of the Prior Art

Pseudo-random numbers are widely used for a variety of purposes. Sequences of values created by pseudo-random number generators are most useful if they appear to have been generated by random processes. Further, the sequences of values created by pseudo-random number processes should be adequately distributed across the range of potential output values that would have resulted from the intended random process. Ideally, sequences of pseudo-random values should not exhibit discernable patterns or other observable relationships among the output values that would make their deterministic characteristics known.

Many pseudo-random number generator processes have been created. The linear feedback shift register (LFSR) process is easily implemented and has been widely used but suffers inherent weakness from the strict linearity of its design. Another widely used process is the classic linear congruential generator (LCG). For example, the LCG process is the framework used by DeVane in the high-speed pseudo-random number generator of U.S. Pat. No. 5,187,676, by Finkelstein in the encryption protection in a communication system of U.S. Pat. No. 6,014,446, by Tiedemann et al. in the system for testing a digital communication channel of U.S. Pat. No. 5,802,105, by Ridenour in the high precision pseudo-random number generator of U.S. Pat. No. 5,541,996, and by Shimada in the pseudo-random number generator of U.S. Pat. No. 6,097,815. LCG-based systems can generate well mixed numbers and pass a number of statistical tests. However, the pseudo-random number sequence generated by an LCG process often can be inferred even if the parameters of the process are all unknown.

The multiple recursive generator (MRG) process extends the range of recursion from the immediately preceding output value of the LCG process to more distantly produced ones. Lagged Fibonacci generators and some combined generators are MRG processes. The LCG process also has been extended to additional dimensions to create a matrix method (MM). Niederreiter introduced the multiple-recursive matrix method (MRMM) as a framework for encompassing essentially all of the linear methods described above as well as several others such as the Generalized Feedback Shift Register (GFSR) and the “twisted” GFSR. An example of the twisted GFSR is the Mersenne Twister described by Matsumoto and Nishimura.

Another class of pseudo-random generator processes was created by the authors of the current invention and was denoted as a multiple variable recursive matrix (MVRM) process. As described in U.S. patent application Ser. No. 10/646,939 dated Aug. 21, 2003, the new class of MVRM pseudo-random number generator processes is well suited to general-purpose applications and generates output sequences with very long periods and very low predictability.

All of the previously described pseudo-random generator processes use primarily linear mathematical operations or similar variants to create the pseudo-random output values. In 1965, MacLaren and Marsaglia suggested a non-linear enhancement by using one pseudo-random number sequence to permute the elements of another pseudo-random number sequence. The process was succinctly described by Knuth (The Art of Computer Programming, Volume 2, Seminumerical Algorithms, Third Edition, 1997, Addison Wesley, page 34) as randomizing by shuffling and denoted as Algorithm M. Such shuffling can lead to very long sequence periods and appears to attenuate the relationship of initially nearby terms in the output sequence.

In algorithm M, two pseudo-random number sequences (Xₙ) and (Yₙ) are created by separate initial pseudo-random number generator processes. An auxiliary table V[0], V[1], . . . , V[k−1] is established where k is some number chosen for convenience, usually in the neighborhood of 100. The V-table initially is filled with the first k values of the X-sequence. To generate a final output sequence of pseudo-random number values, the following steps are repeatedly executed:
1) The next elements of the (Xₙ) and (Yₙ) sequences are generated;
2) A pointer j is set to an element of the range 0≦j≦k as determined by the most recently generated element of (Yₙ) from step 1 through the process j=[kY/m] where Y is the most recently generated value of the (Yₙ) sequence, m is the modulus used in the sequence (Yₙ) and k is the number chosen as the length of the auxiliary table V;
3) The output value is selected by pointer j from the auxiliary table V to be V[j];
4) The auxiliary table V is updated by replacing the V[j] element with the most recently generated element of (Xₙ) from step 1.

An alternative shuffling approach that uses a single pseudo-random number sequence to permute the elements of that same pseudo-random number sequence was described by Knuth (page 33) as Algorithm B.

In algorithm B, a single pseudo-random number sequence (Xₙ) is created by an initial pseudo-random number generator process. An auxiliary table V[0], V[1], . . . , V[k−1] is established where k is some relatively small number again chosen for convenience. The V-table initially is filled with the first k values of the X-sequence. The variable Y initially is set equal to the (k+1)st value of the X-sequence. To generate a final output sequence of pseudo-random number values, the following steps are repeatedly executed:
1) A pointer j is set to an element of the range 0≦j≦k as determined by the variable Y through the process j=[kY/m] where m is the modulus used in the sequence (Xₙ) and k is the number chosen as the length of the auxiliary table V;
2) The output value is selected by pointer j from the auxiliary table V to be V[j];
3) The variable Y is set to the output value V[j];
4) The next element of the (Xₙ) sequence is generated;
5) The auxiliary table V is updated by replacing the V[j] element with the most recently generated element of (Xₙ) from step 4.

Knuth's example for Algorithm M (page 33) uses an LCG pseudo-random number generator for both the (Xₙ) and (Yₙ) sequences with initial elements of X₁=5772156649, X₂=29774336634, X₃=19657136912, Y₁=1781072418, Y₂=23044562359 and Y₃=471691136 with k=64 and m=34359738368. In the example, the first element of the (Xₙ) sequence, 5772156649, is chosen by the j pointer as the third output element created by the composite process. Since an LCG pseudo-random number generator will loop through the sequence of all other possible values before returning to any initial value, the (Xₙ) sequence will be generated to include 2³⁵ or 34,359,738,368 other values before the value of 5772156649 is once again generated and included in the auxiliary table V. Therefore, once the example version of algorithm M creates any specific output value, that same value cannot be created as any one of at least the next 34 billion output values. Conversely, for a truly random process the probability of any given number occurring at any point in the sequence would be identical to that of it occurring at any other point in the sequence. The probability of a specific number occurring at least once in a truly random (Xₙ) sequence of 34 billion elements from a potential set of 34,359,738,368 elements would be about 98.953%. Using Knuth's example for algorithm M, however, once a specific value has occurred, the probability of that same value recurring in the next 34 billion elements is absolutely zero. After the cycle has been fully completed (having generated 34,359,738,368 elements) and the specific value has been generated again in the (Xₙ) sequence and loaded into the auxiliary table V, that specific value is nearly certain to be included as one of the next 1000 output values. Specifically, were the (Yₙ) sequence used to select from the auxiliary table to be completely random (such as a coin toss), the probability of a single item in a list of 64 elements being chosen within 1000 tries is about 99.99999%. Thus, while Algorithm M introduces some shuffling of the (Xₙ) sequence into the output sequence, Algorithm M does not create the types of probabilities of element occurrences that would be expected of a truly random process.

Algorithm B suffers from the same fundamental shortcoming as Algorithm M. Once any given value of the (Xₙ) sequence has been generated and loaded into the auxiliary table V, that value will almost certainly appear in the output stream within the next 1000 elements and then it will not appear again for a very, very long time. Thus, the probabilities of elements occurring in an output stream generated by either Algorithm M or Algorithm B are not representative of those expected from truly random processes, severely limiting their use as pseudo-random number generators in more demanding applications.

Further, shuffling methods exhibit a characteristic property that is generally understood to be an inherent defect; shuffling methods do not alter any generated values that are included in the potential output table but simply vary the order in which those values are extracted from the table. (Knuth, page 34) Compounding that identified flaw, if the initial pseudo-random number generator processes fail some tests of randomness such as the “birthday spacings” test or the random-walk test, the shuffled sequences also will fare poorly on those tests.

Most pseudo-random number generators including algorithm M and algorithm B are designed to create uniformly distributed results. For applications that require final sequences of values with specific non-uniform distribution characteristics, the uniformly distributed results from most pseudo-random number generators must be transformed through mathematical manipulations to create output values with the desired distribution characteristics. This transformation is generally a subsequent, additional step in the creation of the pseudo-random number values.

The invention described herein presents a general, non-linear pseudo-random number generator process offering output sequence element probabilities comparable to those expected of truly random processes. The current invention transforms the perceived weakness of shuffling-type processes into an exceptionally powerful alternative that can create pseudo-random number output sequences capable of passing the “birthday spacings”, random-walk and other known tests even when the underlying pseudo-random number generating components do not. Finally, the current invention introduces a process for creating pseudo-random number output sequences with defined distribution characteristics without the need for secondary processing of the output sequence.

### SUMMARY AND OBJECTS OF THE INVENTION

A primary object of the present invention is to provide a method and process for generating pseudo-random numbers with output sequence characteristics comparable to those of truly random processes, capable of producing specifically defined output sequence distribution characteristics and with very long period non-repeating output sequences.

Another object of the present invention is to introduce a pseudo-random generator process that will pass known tests such as the “birthday spacings” and random-walk tests even when its underlying pseudo-random number generating components do not pass those tests.

These objects are achieved by introducing a new type of pseudo-random number generator process that significantly extends the current state of the art. The pseudo-random generator process of the instant invention can be denoted as defined-distribution expanded shuffling (DDES) generators. As described in the following sections, the new class of DDES pseudo-random number generators of this invention is well suited to general-purpose applications where the characteristic distribution of the output sequence should satisfy specifically designated distributional properties.

Distributional characteristics of output sequences created by pseudo-random number generator processes have always been a major concern. Most pseudo-random number generators are designed to create uniformly distributed results. Those results have often been transformed through mathematical manipulations to create final sequences of values with specific non-uniform distributional characteristics. The pseudo-random number generator processes of the current invention can create both uniformly distributed and non-uniformly distributed output sequences without the need for subsequent mathematical augmentation.

The demonstrable levels of “randomness” also have been a concern in the design of pseudo-random number generators. Many tests have been devised that indicate the “randomness” of a sequence of values generated by a pseudo-random number generator. While passing such tests is no guaranty of acceptable randomness, failure of such tests usually indicates a weakness in the pseudo-random number generator. The pseudo-random number generator processes of the claimed invention create output sequences that satisfy known randomness tests such at the “birthday spacings” and random-walk tests that other pseudo-random number generators, including its underlying pseudo-random number generating components, are known to fail.

A first version of the defined-distribution expanded shuffling (DDES) pseudo-random number generator of the present invention is similar to Algorithm M in that each uses two pseudo-random number sequences (Xₙ) and (Yₙ) that are created by separate component pseudo-random number generator processes. Unlike Algorithm M, the DDES process of the present invention uses a defined-distribution table D[0], D[1], . . . , D[k+z−1] where k and z are chosen with specific consideration given to the range of values desired in the output sequence; that is, k should be no smaller than the number of possible elements of the output sequence, p, and ideally should be much larger than p, and a is chosen such that (k+z) mod p≡0 where z≧0. The defined-distribution table D initially is filled with (k+z) values satisfying the desired output distribution characteristics as described in a following section. The defined-distribution table D contains all possible values of the entire output sequence at least once and, depending on the desired output distribution, may include some or many values more than once. Output elements are chosen from the defined-distribution table D by a component pseudo-random number generation sequence (Yₙ) and elements of the defined-distribution table D are shuffled by application of another component pseudo-random number generation sequence (Xₙ). The range of possible values in the component pseudo-random number generation sequence (Yₙ) is represented by the variable m_{y} that should ideally satisfy the condition that m_{y} be equal to or greater than k. The variable mₓ represents the range of possible values in the component pseudo-random number generation sequence (Xₙ) and the value for mₓ should ideally satisfy the condition that mₓ be equal to or greater than (k+z).

To generate a final output sequence of pseudo-random number values, the following steps are repeatedly executed:
1) The next elements of the (Xₙ) and (Yₙ) sequences are generated;
2) A pointer j is set to an element of the range 0≦j<k as determined by the most recently generated element of (Yₙ) from step 1;
3) The output value is selected by pointer j from the defined-distribution table D to be D[j];
4) A pointer h is set to an element of the range 0≦h<(k+z) as determined by the most recently generated element of (Xₙ) from step 1;
5) The defined-distribution table D is updated by switching the entries for the D[h] and the D[j] elements.

The creation of the pointers h and j are ideally implemented by the following:
h=[(k+z)X/mₓ] where:
   X is the most recently generated element of (Xₙ),
   mₓ, is the range of possible values in the sequence (Xₙ), and
   (k+z) is the number chosen as the length of the defined-distribution table D;
j=[kY/m_{y}] where:
   Y is the most recently generated element of (Yₙ),
   m_{y} is the range of possible values in the sequence (Yₙ), and
   k is the number chosen as the partial length of the defined-distribution table D.

Since h and j are discrete pointers into the defined-distribution table D, each must be an integer value. An alternative formulation of h and j that does not change the fundamental nature of the DDES process is h=X mod (k+z) and j=Y mod k.

The defined-distribution table D initially is filled with (k+z) values to meet the specifications of the desired output distribution characteristics. For a desired uniform distribution over the range of 0 to p−1, the D table should be filled with (k+z)/p entries of each value from (and including) 0 to p−1. For example, with p set to 256, k set to 1134 and z set to 146, the D table would contain 1280 elements with a uniform distribution over the range of 0 to 255 as specified by p, while the D table would contain five occurrences of each number in that range (five 0s, five 1s, . . . and five 255s).

The defined-distribution table D may be initially filled with (k+z) values to meet the specifications of virtually any desired output distribution characteristics. For example, the sum of two randomly rolled dice covers a possible range of values from 2 to 12 with a binomial distribution. A full set of possible outcomes is represented by a single 2 and 12 entry, two 3 and 11 entries, three 4 and 10 entries, four 5 and 9 entries, five 6 and 8 entries and six 7 entries for a total of 36 entries. To create a desired distribution representing the sum of two dice, the D table would be filled with (k+z)/p entries where p=36 and (k+z) is an integral multiple of 36. For example, with p set to 36, k set to 729 and z set to 27, the D table would contain 756 elements (that is, 36 times 21) and should be initialized with twenty-one 2s and 12s, forty-two 3s and 11s, . . . and one hundred twenty-six 7s. Because the shuffling processes of the present invention do not change the potential output values but just the order in which they are arranged, any given distribution of values, once loaded into the defined-distribution table D, will be directly reflected in the distribution of the final output values.

The order of the elements used to initially fill the defined-distribution table D should ideally be rearranged prior to the generation of the output pseudo-random number sequence. A defined-distribution table D initially filled with (k+z) values meeting the requirements of the desired distribution and using an initial (Xₙ) sequence is rearranged prior to use by repeatedly executing the following steps:
1) The next i elements of the (Xₙ) sequence are generated where i≧2;
2) The pointers hᵢ are set to elements of the range 0≦hᵢ<(k+z) as determined by the i most recently generated elements of (Xₙ) from step 1;
3) The defined-distribution table D is updated by shifting the entries through the set of pointers hᵢ so that D[temp]←D[h₁], D[h₁]←D[h₂], D[h₂]←D[h₃], . . . D[hᵢ₋₁]←D[hᵢ] and D[h_{i]←D[temp].}

The creation of the pointers hᵢ is beneficially implemented by the following:
hᵢ=[(k+z)Xᵢ/mₓ] where:
Xᵢ is the ith most recently generated element of (Xₙ),
mₓ is the range of possible values in the sequence (Xₙ) and
(k+z) is the chosen length of the defined-distribution table D.

Since the hᵢ are discrete pointers into the defined-distribution table D, each must be an integer value. An alternative formulation of hᵢ that does not change the fundamental nature of the DDES process would be hᵢ=Xᵢ mod (k+z).

A second version of the defined-distribution expanded shuffling (DDES) pseudo-random number generator of the present invention also uses two pseudo-random number sequences (Xₙ) and (Yₙ) that are created by separate component pseudo-random number generator processes. For the second version of DDES, a defined-distribution table D[0], D[1], . . . , D[k+z−1] is established where, as before, k and z are chosen with specific consideration given to the range of values desired in the output sequence; that is, k should be no smaller than the number of possible elements of the output sequence, p, and ideally should be much larger than p, and z is chosen such that (k+z) mod p≡0 where z≧0. The defined-distribution table D initially is filled with (k+z) values as previously described. The defined-distribution table D contains all possible values of the entire output sequence at least once and, depending on the desired output distribution, may include some or many values more than once. As before, output elements are chosen from the defined-distribution table D by a component pseudo-random number generation sequence (Yₙ) and elements of the defined-distribution table D are shuffled by application of another component pseudo-random number generation sequence (Xₙ). The range of possible values in the component pseudo-random number generation sequence (Yₙ) is represented by the variable m_{y} that should ideally satisfy the condition that m_{y} be equal to or greater than k. The variable mₓ represents the range of possible values in the component pseudo-random number generation sequence (Xₙ) and the value for mₓ should ideally satisfy the condition that mₓ be equal to or greater than (k+z).

To generate a final output sequence of pseudo-random number values, the following steps are repeatedly executed:
1) The next element of the (Yₙ) sequence and the next i elements of the (Xₙ) sequence are generated where i≧2;
2) The pointer j is set to an element of the range 0≦j≧k as determined by the most recently generated element of (Yₙ) from step 1;
3) The output value is selected by pointer j from the defined-distribution table D to be D[j];
4) The pointers hᵢ are set to elements of the range 0≦hᵢ<(k+z) as determined by the i most recently generated elements of (Xₙ) from step 1;
5) The defined-distribution table D is updated by shifting the entries through the set of pointers hᵢ so that D[temp]←D[hᵢ], D[hᵢ]←D[h₂], D[h₂]←D[h₃], . . . D[hᵢ₋₁]←D[hᵢ] and D[hᵢ]←D[temp].

The creation of the pointers hᵢ and j is beneficially implemented by the following:
hᵢ=[(k+z)Xᵢ/mₓ] where:
   Xᵢ is the ith most recently generated element of (Xₙ),
   mₓ, is the range of possible values in the sequence (Xₙ) and
   (k+z) is the chosen length of the defined-distribution table D;
j=[kY/m_{y}] where:
   Y is the most recently generated element of (Yₙ),
   m_{y} is the range of possible values in the sequence (Yₙ), and
   k is the number chosen as the partial length of the defined-distribution table D.

Since the hᵢ and j are discrete pointers into the defined-distribution table D, each must be an integer value. An alternative formulation of hᵢ and j that does not change the fundamental nature of the DDES process would be hᵢ=Xᵢ mod (k+z) and j=Y mod k.

Without loss of generality and identical in concept to the second version of the DDES process described above, the ith most recently generated elements of (Xₙ) could be replaced with the single most recently generated elements of i separate component pseudo-random number generation sequences (Xiₙ).

A third version of the defined-distribution expanded shuffling (DDES) pseudo-random number generator of the present invention is similar to Algorithm B in that each uses a single pseudo-random number sequence (Yₙ) that is created by a separate component pseudo-random number generator process. Unlike Algorithm B, the DDES process of the present invention uses a defined-distribution table D[0], D[1], . . . , D[k+z−1] where k and z are chosen with specific consideration given to the range of values desired in the output sequence; that is, k should be no smaller than the number of possible elements of the output sequence, p, and ideally should be much larger than p, and z is chosen such that (k+z) mod p≡0 where z≧0. The defined-distribution table D initially is filled with (k+z) values satisfying the desired output distribution characteristics as described above. The defined-distribution table D contains all possible values of the entire output sequence at least once and, depending on the desired output distribution, may include some or many values more than once. Output elements are chosen from the defined-distribution table D by a component pseudo-random number generation sequence (Yₙ). Also unlike Algorithm B, the DDES process does not create additional pointers from the output elements since the range of elements in the output sequence may be much smaller than the size of the defined-distribution table D. Instead, elements of the defined-distribution table D are shuffled by application of the current and prior elements of the single component pseudo-random number generation sequence (Yₙ). The range of possible values in the component pseudo-random number generation sequence (Yₙ) is represented by the variable m_{y} that should ideally satisfy the condition that m_{y} be equal to or greater than k.

To generate a final output sequence of pseudo-random number values, the following steps are repeatedly executed:
1) The next element of the (Yₙ) sequence is generated;
2) The pointer j is set to an element of the range 0≦j<k as determined by the most recently generated element of (Yₙ) from step 1;
3) The output value is selected by pointer j from the defined-distribution table D to be D[j];
4) The pointers hᵢ are set to elements of the range 0≦hᵢ<(k+z) as determined by the ith prior generated element of (Yₙ) from step 1;
5) The defined-distribution table D is updated by shifting the entries through the set of pointers hᵢ so that D[temp]←D[h₁], D[h₁]←D[h₂], D[h₂]←D[h₃], . . . D[hᵢ₋₁]←D[hᵢ] and D[hᵢ]←D[temp].

The creation of the pointers hᵢ and j is beneficially implemented by the following:
hᵢ=[(k+z)Yᵢ/mₓ] where:
   Yᵢ is the ith prior generated element of (Yₙ),
   m_{y} is the range of possible values in the sequence (Yₙ) and
   (k+z) is the chosen length of the defined-distribution table D;
j=[kY/m_{y}] where:
   Y is the most recently generated element of (Yₙ),
   m_{y} is the range of possible values in the sequence (Yₙ) and
   k is the number chosen as the partial length of the defined-distribution table D.

Since all the hᵢ and j are discrete pointers into the defined-distribution table D, each must be an integer value. An alternative formulation of hᵢ and j that does not change the fundamental nature of the DDES process is hᵢ=Yᵢ mod (k+z) and j=Y mod k.

Alternatively, because the hᵢ pointers of step 4 are all derived from the same component pseudo-random number generation sequence (Yₙ), the pointers hᵢ could be set to elements of the range 0≦hᵢ<(k+z) as determined by an ith number of prior generated elements of (Yₙ) from step 1 that were not in immediately preceding order. For instance, the h₁ pointer could be the second preceding element of (Yₙ), the h₂ pointer could be the fifth preceding element of (Yₙ), the h₃ pointer could be the eleventh preceding element of (Yₙ), etc. so that successive applications of step 5 would result in a wider variety of elements being rearranged.

A key innovation of the present invention is the introduction of the defined-distribution table D; the values contained therein, once established, remain unchanged through the subsequent operation of the pseudo-random number generator. Conventional wisdom considers the failure of shuffling methods to introduce different values into the output sequence as an inherent defect. However, the current invention uses this “defect” of shuffling methods to create a process with distinct advantages. The shuffling processes of the present invention do not change the possible output values but just alter the order in which they are arranged in the defined-distribution table D. Through the selection of elements from the defined-distribution table D, any arbitrary distribution of values, once loaded into table D, will be directly reflected in the distribution of the final output values.

Another key innovation of the present invention is the introduction of the distinctive condition that k, the length of the defined-distribution table D, must be chosen to be equal to or greater than p, the number of possible elements in the output sequence. This condition is dramatically different from those of Algorithm M and Algorithm B. In those processes, the auxiliary table V contains a very small fraction of the possible output values—less than 0.0000003% of them. By contrast, the specifications of the current invention require that defined-distribution table D contain at least 100% of the possible output values. Ideally, each possible output value would be represented multiple times in the defined-distribution table D by choosing a value of k that is many times larger than p, the number of possible output values. Large values of k would create conditions for which the recurrence of any item in the output stream would not necessarily refer to the same element in the D, relaxing what would otherwise be more stringent requirements for the selection process (driven by a separate component pseudo-random number generator) in order to produce suitably “random” results. Ultimately, this feature of the claimed process results in a series of generated numbers that suitably reflect the characteristics of a truly randomly generated set of numbers.

A final key innovation of the present invention is the introduction of greatly expanded shuffling for the defined-distribution table D, using multiple outputs from a single component pseudo-random number generator or single outputs from multiple, separate component pseudo-random number generators for every round of pseudo-random number generation. This extended shuffling could be expanded to the extent that virtually every item in the defined-distribution table D was shuffled before every new selection from the table. The greatly expanded shuffling also would relax what would otherwise be more stringent requirements for the component pseudo-random number selection process in order to produce suitably “random” results.

The DDES pseudo-random number generators of this invention effectively incorporate component pseudo-random number generator processes into the generation of the final pseudo-random number output sequence. The component pseudo-random number generator processes can be designed from any of a number of well-known alternatives including the linear congruential, multiple recursive, matrix method, multiple-recursive matrix method or the multiple variable recursive matrix processes previously described. The output from the DDES pseudo-random number generators of this invention could be used as separate component pseudo-random number generators for another DDES process. Many of these component pseudo-random number generator processes can be created to generate exceptionally long cycle lengths (the number of periods before the generator begins to repeat its output sequence). Through the combination of long-period shuffling and long-period selection sequences, the DDES pseudo-random number generators of this invention yield even substantially longer final output sequence periods. For even single component pseudo-random number generators such as the third version of the DDES process described above, the final output sequence periods may be much longer than the length of the component sequence period because the defined-distribution table D does not necessarily return to its original status when the selection sequence does. Finally, when multiple component pseudo-random number generators are used, ideally the component sequence period lengths should ideally be chosen to be distinct; that is, no component sequence period length should be the same as another. Often, the length of the composite final output sequence created by the combined component sequences has a cycle length much greater than the product of all the component sequence lengths because the defined-distribution table D does not necessarily return to its original status when the component sequences do.

### BRIEF DESCRIPTION OF THE DRAWINGS

FIG. 1 is a block diagram depicting the functional components and sequential operation of the defined-distribution expanded shuffling (DDES) pseudo-random number generator, according to the invention claimed herein.

FIG. 2 is a block diagram depicting the general initialization process for the defined-distribution table D of the DDES pseudo-random number generator, according to the invention claimed herein.

FIG. 3 is a block diagram depicting the functional components and sequential operation of the DDES pseudo-random number generator with a single output pointer from the component pseudo-random number generator Y and a single shift pointer from the component pseudo-random number generator X for each step of the process, according to the invention claimed herein.

FIG. 4 is a block diagram depicting the functional components and sequential operation of the DDES pseudo-random number generator with a single output pointer from the component pseudo-random number generator Y and multiple shift pointers from the component pseudo-random number generator X for each step of the process, according to the invention claimed herein.

FIG. 5 is a block diagram depicting the functional components and sequential operation of the DDES pseudo-random number generator with a single output pointer from the component pseudo-random number generator Y and multiple shift pointers from the same component pseudo-random number generator Y for each step of the process, according to the invention claimed herein.

FIG. 6 is a block diagram depicting an example of the sequential operation of the functional components of the DDES pseudo-random number generator with a single output pointer from a component pseudo-random number generator Y with specified elements [255, 121, 423, 335] and multiple shift pointers from a component pseudo-random number generator X with initial specified elements [144, 321, 372, 235, 364; 258, 447, 362, 172, 465; 64, 386, 208, 107, 17] for each step of the process, according to the invention claimed herein.

### DESCRIPTION OF THE PREFERRED EMBODIMENT

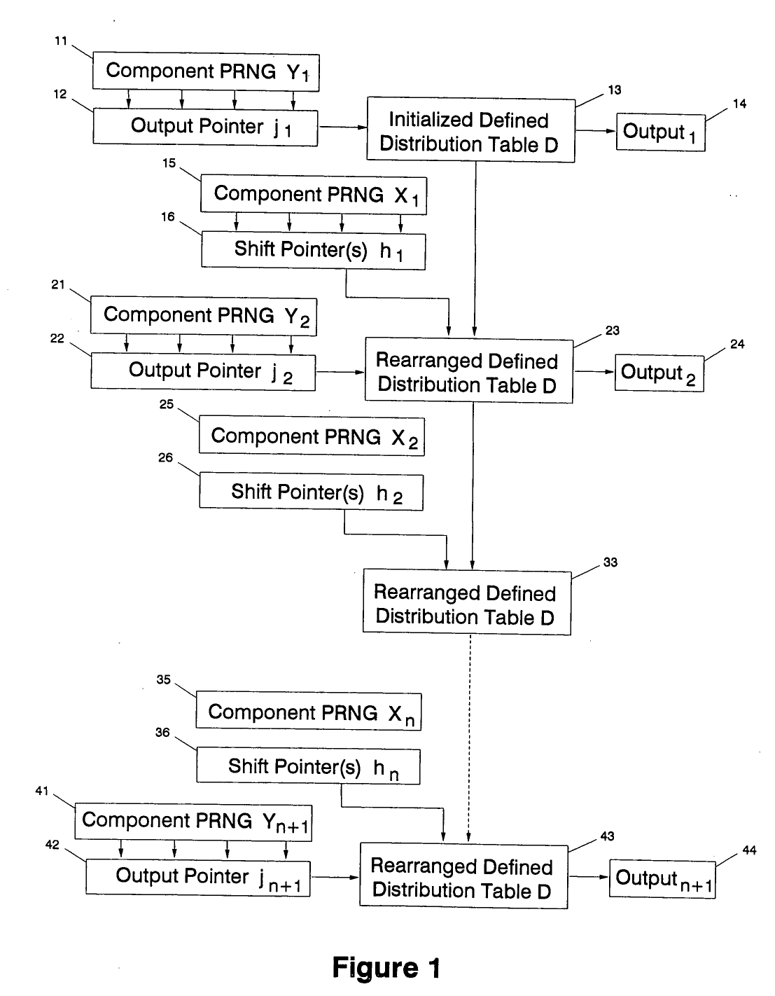

Referring to FIG. 1, a block diagram of the defined-distribution expanded shuffling (DDES) pseudo-random number generator system of the claimed invention is shown that incorporates an initialized defined-distribution table 13, a first element from a component pseudo-random number generator Y 11, a first output pointer j 12, a selected first output element 14, a first (set of) element(s) from a component pseudo-random number generator X 15, a first (set of) shift pointer(s) h 16, and a first rearranged defined-distribution table 23. Generation of subsequent rounds of output elements are represented by a second element from a component pseudo-random number generator Y 21, a second output pointer j 22, a selected second output element 24, a second (set of) element(s) from a component pseudo-random number generator X 25, a second (set of) shift pointer(s) h 26, and a second rearranged defined-distribution table 33; and eventually by an n^{th} (set of) element(s) from a component pseudo-random number generator X 35, an n^{th} (set of) shift pointer(s) h 36, an n^{th} rearranged defined-distribution table 43, an n+1^{th} element from a component pseudo-random number generator Y 41, an n+1^{th} output pointer j 42, and an n+1^{th} selected output element 44.

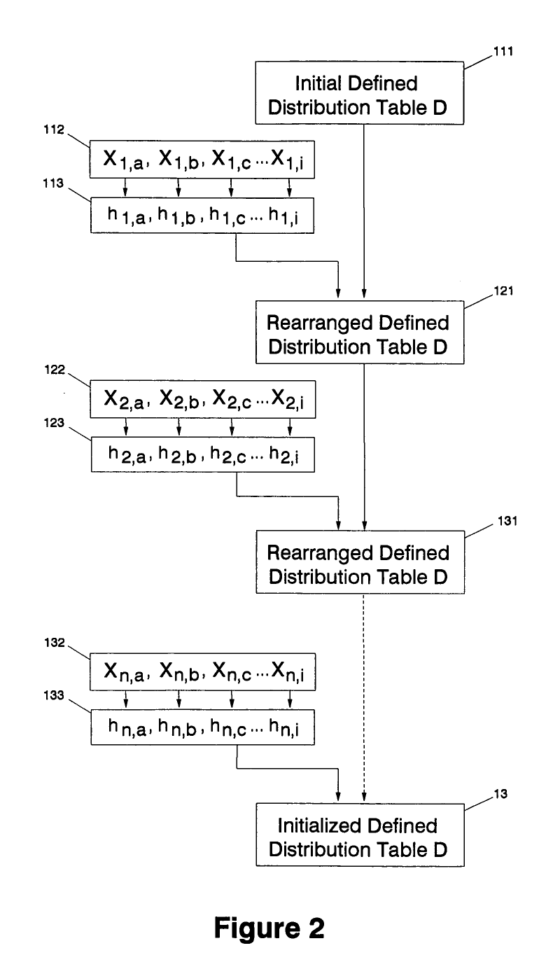

The initialized defined-distribution table 13 consists of a user-specified set of possible output values that have been initialized by the process shown in FIG. 2. In that process, the chosen, specified set of possible output values are loaded into an initial defined-distribution table and rearranged for a specified number of cycles to create the initialized defined-distribution table (13 in FIG. 2). The first element from the component pseudo-random number generator Y 11 is generated by an independent pseudo-random number generator process beneficially consisting of virtually any type of pseudo-random number generator process established with specified seed values. The first output pointer j 12 is created from the first element from the component pseudo-random number generator Y 11. A variety of processes may be used to create the first output pointer j 12, such as using a multiplicative assignment kY/m_{y} where m_{y} is the modulus used in the component pseudo-random number generator Y or, more generally, where m_{y} is simply the range of values created by the component pseudo-random number generator Y, k is a number chosen to be smaller than the size of the initialized defined-distribution table 13 and represents the selectable portion of the initialized defined-distribution table 13 and m_{y} should ideally satisfy the condition that m_{y} is equal to or greater than k. Alternatively, the first output pointer j 12 is created from the first element from the component pseudo-random number generator Y 11 using a modular reduction assignment Y mod k or from any other process that maps the values of the range of elements of the series Y generated by the component pseudo-random number generator onto the range k of the selectable portion of the initialized defined-distribution table 13. The first output element 14 of the DDES pseudo-random number generator system of the claimed invention is the element of the initialized defined-distribution table 13 selected by the first output pointer j 12. The first (set of) element(s) from the component pseudo-random number generator X 15 is generated by an independent pseudo-random number generator process beneficially consisting of a set of initialization cycles of virtually any type of pseudo-random number generator process established with specified seed values. The first (set of) shift pointer(s) h 16 is created from the first (set of) element(s) from the component pseudo-random number generator X 15, using any of a number of possible processes. For example, the first set of shift pointers h 16 can be created using a multiplicative assignment (k+z)X/mₓ where mₓ is the modulus used in the component pseudo-random number generator X or, more generally, where mₓ is simply the range of values created by the component pseudo-random number generator X, z is the number chosen such that (k+z) is the size of the entire initialized defined-distribution table 13 and mₓ should ideally satisfy the condition that mₓ is equal to or greater than (k+z). Alternatively, the first (set of) shift pointer(s) h 16 is created from the first (set of) element(s) from the component pseudo-random number generator X 15 using a modular reduction assignment X mod (k+z) or from any other process that maps the values of the range of elements of the series X generated by the component pseudo-random number generator onto the range (k+z) of the entire initialized defined-distribution table 13. The first rearranged defined-distribution table 23 can conveniently be created from the initialized defined-distribution table 13 by rearranging the positions of elements in the initialized defined-distribution table 13 using the first (set of) shift pointer(s) h 16 separately from or in conjunction with the first and/or previous (set of) output pointer(s) j 12 created from the component pseudo-random number generator Y.

The rearranged defined-distribution table 23 created from the first cycle of the pseudo-random number generator system of the claimed invention consists of the same specified set of possible output values that was present in the initialized defined-distribution table 13. The second element from the component pseudo-random number generator Y 21 is generated by the next cycle of the independent pseudo-random number generator process Y. The second output pointer j 22 can conveniently be created from the second element from the component pseudo-random number generator Y 21 using a multiplicative assignment, modular reduction assignment or other mapping assignment process from the range of elements of the series Y generated by the component pseudo-random number generator onto the range k of the selectable portion of the rearranged defined-distribution table 23. The second output element 24 of the DDES pseudo-random number generator system of the claimed invention is the element of the rearranged defined-distribution table 23 selected by the second output pointer j 22. The second (set of) element(s) from the component pseudo-random number generator X 25 is generated by the next cycle of the independent pseudo-random number generator process X. The second (set of) shift pointer(s) h 26 can beneficially be created from the second (set of) element(s) from the component pseudo-random number generator X 25 using a multiplicative assignment, modular reduction assignment or other mapping assignment process from the range of elements of the series X generated by the component pseudo-random number generator onto the range (k+z) of the entire rearranged defined-distribution table 23. The second rearranged defined-distribution table 33 is created from the first rearranged defined-distribution table 23 by rearranging the positions of elements in the first rearranged defined-distribution table 23 using the second (set of) shift pointer(s) h 26 separately from or in conjunction with the second and/or previous (set of) output pointer(s) j 22 created from the component pseudo-random number generator Y.

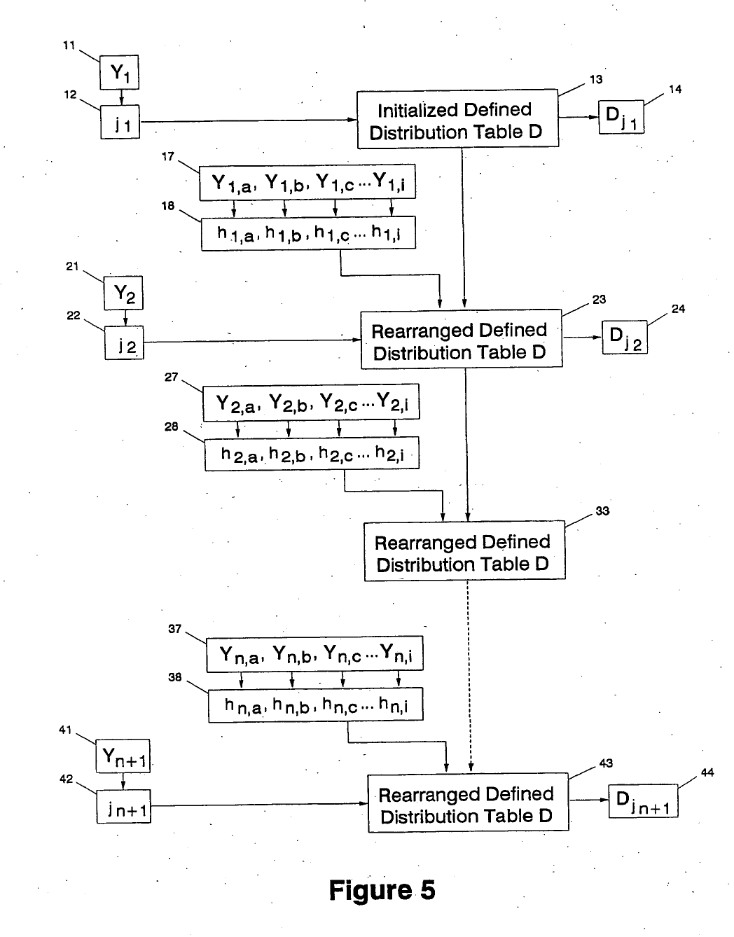

Subsequent cycles of operation of the pseudo-random number generator system of the claimed invention are shown in FIG. 1 as the n+1^{th} cycle where the nth rearranged defined-distribution table 43 is created from the prior rearranged defined-distribution table using the n^{th} (set of) element(s) from the component pseudo-random number generator X 35 to create the resulting n^{th} (set of) shift pointer(s) h 36. Alternatively, as shown in FIG. 5, the n^{th} and/or (set of) previous output pointer(s) j 22, 12 created from the component pseudo-random number generator Y can be used to rearrange the positions of elements in the n−1^{th} rearranged defined-distribution table and create the n^{th} rearranged defined-distribution table 43. The n+1^{th} element from the component pseudo-random number generator Y 41 is generated by the next cycle of the independent pseudo-random number generator process Y from which the n+1^{th} output pointer j 42 is created. The n+1^{th} output element 44 of the DDES pseudo-random number generator system of the claimed invention is the element of the n^{th} rearranged defined-distribution table 43 selected by the n+1^{th} output pointer j 42.

In FIG. 2, a general initialization process for the defined-distribution table D of the claimed invention is shown that incorporates an initial defined-distribution table 111, a first set of elements from a component pseudo-random number generator X 112, a first set of shift pointers h 113, and a first rearranged defined-distribution table 121. Subsequent rounds initializing the defined-distribution table 13 are represented by a second set of elements from a component pseudo-random number generator X 122, a second set of shift pointers h 123, and a second rearranged defined-distribution table 131; and eventually by an n^{th} set of elements from a component pseudo-random number generator X 132, an n^{th} set of shift pointers h 133, and an n^{th} rearranged defined-distribution table that becomes the fully initialized defined-distribution table 13 that is used in FIGS. 1 and 3-5.

The initial defined-distribution table 111 conveniently consists of a user-specified set of possible output values chosen to exhibit desired distribution characteristics that is loaded into an initial defined-distribution table 111. The first set of elements from the component pseudo-random number generator X 112 is generated by an independent pseudo-random number generator process beneficially consisting of a set of initialization cycles of virtually any type of pseudo-random number generator process established with specified seed values. The first set of shift pointers h 113 may be created from the set of first elements from the component pseudo-random number generator X 112 using a multiplicative assignment (k+z)X/mₓ where mₓ is the modulus used in the component pseudo-random number generator X or, more generally, where mₓ is simply the range of values created by the component pseudo-random number generator X, z is the number chosen such that (k+z) is the size of the entire defined-distribution table 111 and m, should ideally satisfy the condition that mₓ is equal to or greater than (k+z). Alternatively, the first set of shift pointers h 113 may be created from the first elements from the component pseudo-random number generator X 112 using a modular reduction assignment X mod (k+z) or from any other process that maps the values of the range of elements of the series X generated by the component pseudo-random number generator onto the range (k+z) of the entire initial defined-distribution table 111. The first rearranged defined-distribution table 121 is created from the initial defined-distribution table 111 by rearranging the positions of elements in the initial defined-distribution table 111 using the first set of shift pointers h 113.

The first rearranged defined-distribution table 121 shown in FIG. 2 created from the first cycle of the defined-distribution table initialization process consists of the same specified set of possible output values that had been loaded into the initial defined-distribution table 111. The second set of elements from the component pseudo-random number generator X 122 is generated by the next cycle of the independent pseudo-random number generator process X. The second set of shift pointers h 123 may be conveniently created from the second set of elements from the component pseudo-random number generator X 122 using multiplicative assignment, modular reduction assignment or other mapping assignment process from the range of elements of the series X generated by the component pseudo-random number generator onto the range (k+z) of the entire rearranged defined-distribution table 121. The second rearranged defined-distribution table 131 is conveniently created from the first rearranged defined-distribution table 121 by rearranging the positions of elements in the first rearranged defined-distribution table 121 using the second set of shift pointers h 123.

Subsequent cycles of operation of the defined-distribution table initialization process are shown as the n^{th} cycle where the n^{th} rearranged defined-distribution table 13 is created from the prior rearranged defined-distribution table using the n^{th} set of elements from the component pseudo-random number generator X 132 and the resulting n^{th} set of shift pointers h 133 by rearranging the positions of elements in the n−1^{th} rearranged defined-distribution table. At the conclusion of n initialization cycles, the n^{th} rearranged defined-distribution table 13 becomes the fully initialized defined-distribution table for the operation of the pseudo-random number generator system of the claimed invention as shown in FIGS. 1 and 3-5.

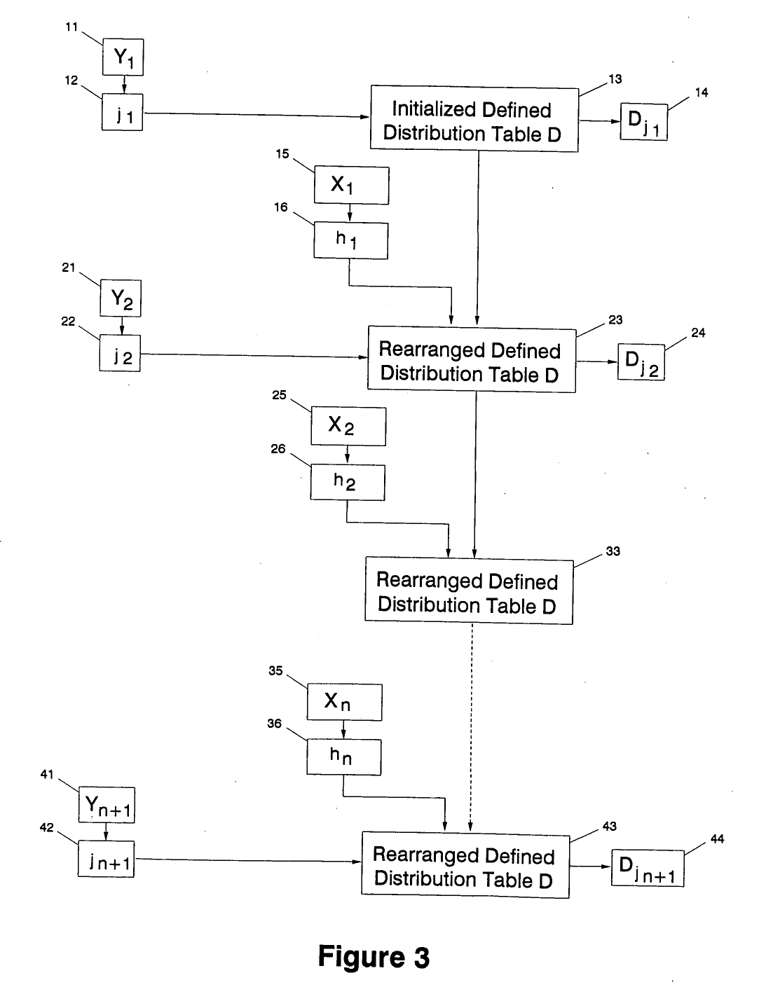

In FIG. 3, one alternative embodiment of the defined-distribution expanded shuffling (DDES) pseudo-random number generator system of the claimed invention is shown that incorporates an initialized defined-distribution table 13, a first element from a component pseudo-random number generator Y₁ 11, a first output pointer j₁ 12, a selected first output element Dⱼ₁ 14, a first element from a component pseudo-random number generator X₁ 15, a first shift pointer h₁ 16, and a first rearranged defined-distribution table 23. Generation of subsequent rounds of output elements are represented by a second element from a component pseudo-random number generator Y₂ 21, a second output pointer j₂ 22, a selected second output element Dⱼ₂ 24, a second element from a component pseudo-random number generator X₂ 25, a second shift pointer h₂ 26, and a second rearranged defined-distribution table 33. Ultimately the process results in an n^{th} element from a component pseudo-random number generator Xₙ 35, an n^{th} shift pointer hₙ 36, an n^{th} rearranged defined-distribution table 43, an n+1^{th} element from a component pseudo-random number generator Yₙ₊₁ 41, an n+1^{th} output pointer jₙ₊₁ 42, and an n+1^{th} selected output element Dⱼₙ₊₁ 44.

In the embodiment shown in FIG. 3, the initialized defined-distribution table 13 consists of a user-specified set of possible output values that have been initialized by the process shown in FIG. 2. In that process, the chosen, specified set of possible output values are loaded into an initial defined-distribution table 111 and rearranged for a specified number of cycles to create the initialized defined-distribution table (13 in FIG. 2). The first element from the component pseudo-random number generator Y₁ 11 is generated by an independent pseudo-random number generator process beneficially consisting of a set of initialization cycles of virtually any type of pseudo-random number generator process established with specified seed values. The first output pointer j₁ 12 can be created from the first element from the component pseudo-random number generator Y₁ 11 using a multiplicative assignment kY₁/m_{y} where m_{y} is the modulus used in the component pseudo-random number generator Y or, more generally, where m_{y} is simply the range of values created by the component pseudo-random number generator Y, k is the number chosen to be smaller than the size of the initialized defined-distribution table 13 and represents the selectable portion of the initialized defined-distribution table 13 and m_{y} should ideally satisfy the condition that m_{y} is equal to or greater than k. Alternatively, the first output pointer j₁ 12 is created from the first element from the component pseudo-random number generator Y₁ 11 using a modular reduction assignment Y₁ mod k or from any other process that maps the values of the range of elements of the series Y generated by the component pseudo-random number generator onto the range k of the selectable portion of the initialized defined-distribution table 13. The first output element Dⱼ₁ 14 of the DDES pseudo-random number generator system of the claimed invention is the element of the initialized defined-distribution table 13 selected by the first output pointer j₁ 12. The first element from the component pseudo-random number generator X₁ 15 is generated by an independent pseudo-random number generator process advantageously consisting of a set of initialization cycles of virtually any type of pseudo-random number generator process established with specified seed values. The first shift pointer h₁ 16 may be created from the first element from the component pseudo-random number generator X₁ 15 using a multiplicative assignment (k+z)X₁/mₓ where mₓ is the modulus used in the component pseudo-random number generator X or, more generally, where mₓ is simply the range of values created by the component pseudo-random number generator X, z is the number chosen such that (k+z) is the size of the entire initialized defined-distribution table 13 and mₓ should ideally satisfy the condition that mₓ is equal to or greater than (k+z). Alternatively, the first shift pointer h₁ 16 is created from the first element from the component pseudo-random number generator X₁ 15 using a modular reduction assignment X₁ mod (k+z) or from any other process that maps the values of the range of elements of the series X generated by the component pseudo-random number generator onto the range (k+z) of the entire initialized defined-distribution table 13. In the embodiment of the process shown in FIG. 3, the first rearranged defined-distribution table 23 is created from the initialized defined-distribution table 13 by switching the positions of elements in the initialized defined-distribution table 13 using the first shift pointer h₁ 16 and the first output pointer j₁ 12 created from the first element from the component pseudo-random number generator Y₁ 11.

For the embodiment shown in FIG. 3, the rearranged defined-distribution table 23 created from the first cycle of the pseudo-random number generator system of the claimed invention consists of the same specified set of possible output values that had been present in the initialized defined-distribution table 13. The second element from the component pseudo-random number generator Y₂ 21 is generated by the next cycle of the independent pseudo-random number generator process Y. The second output pointer j₂ 22 may advantageously be created from the second element from the component pseudo-random number generator Y₂ 21 using a multiplicative assignment, modular reduction assignment or other mapping assignment process from the range of elements of the series Y generated by the component pseudo-random number generator onto the range k of the selectable portion of the rearranged defined-distribution table 23. The second output element Dⱼ₂ 24 of the DDES pseudo-random number generator system of the claimed invention is the element of the rearranged defined-distribution table 23 selected by the second output pointer j₂ 22. The second element from the component pseudo-random number generator X₂ 25 is generated by the next cycle of the independent pseudo-random number generator process X. The second shift pointer h₂ 26 may conveniently be created from the second element from the component pseudo-random number generator X₂ 25 using a multiplicative assignment, modular reduction assignment or other mapping assignment process from the range of elements of the series X generated by the component pseudo-random number generator onto the range (k+z) of the entire rearranged defined-distribution table 23. The second rearranged defined-distribution table 33 is created from the first rearranged defined-distribution table 23 by switching the positions of elements in the first rearranged defined-distribution table 23 using the second shift pointer h₂ 26 and the second output pointer j₂ 22 created from the second element from the component pseudo-random number generator Y₂ 21.

Subsequent cycles of operation of the embodiment of the pseudo-random number generator system of the claimed invention as shown in FIG. 3 are shown as the n+1^{th} cycle where the n^{th} rearranged defined-distribution table 43 is created from the prior rearranged defined-distribution table using the n^{th} element from the component pseudo-random number generator Xₙ 35 to create the resulting n^{th} shift pointer hₙ 36 and the n^{th} output pointer jₙ (not shown) created from the n^{th} element from the component pseudo-random number generator Yₙ (not shown), by rearranging the positions of elements in the n−1^{th} rearranged defined-distribution table. The n+1^{th} element from the component pseudo-random number generator Yₙ₊₁ 41 is generated by the next cycle of the independent pseudo-random number generator process Y from which the n+1^{th} output pointer jₙ₊₁ 42 is created. The n+1^{th} output element Dⱼₙ₊₁ 44 of the DDES pseudo-random number generator system of the claimed invention is the element of the n^{th} rearranged defined-distribution table 43 selected by the n+1^{th} output pointer jₙ₊₁ 42. In this manner, a series of pseudo-random numbers Dⱼ₁ 14, Dⱼ₂ 24, . . . Dⱼₙ₊₁ 44 is generated.

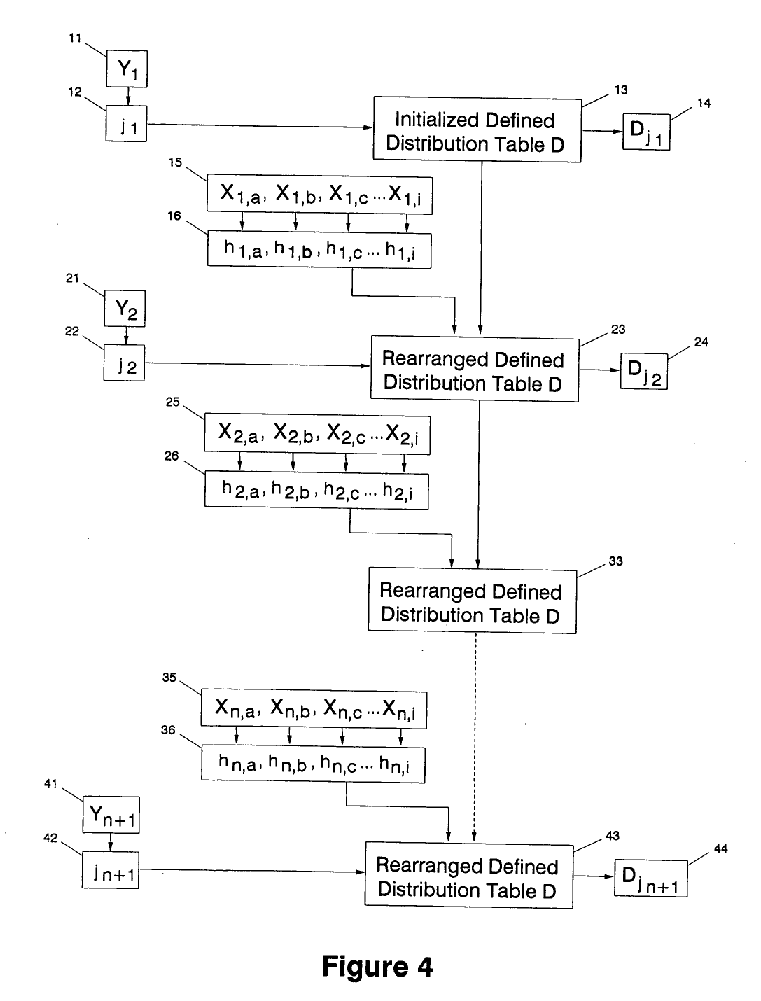

In FIG. 4, an alternative embodiment of the defined-distribution expanded shuffling (DDES) pseudo-random number generator system of the claimed invention is shown that incorporates an initialized defined-distribution table 13, a first element from a component pseudo-random number generator Y₁ 11, a first output pointer j₁ 12, a selected first output element Dⱼ₁ 14, a first set of elements from a component pseudo-random number generator X_{1,a}, X_{1,b}, X_{1,c} . . . X_{1,i} 15, a first set of shift pointers h_{1,a}, h_{1,b}, h_{1,c} . . . h_{1,i} 16, and a first rearranged defined-distribution table 23. Generation of subsequent rounds of output elements are represented by a second element from a component pseudo-random number generator Y₂ 21, a second output pointer j₂ 22, a selected second output element Dⱼ₂ 24, a second set of elements from a component pseudo-random number generator X_{2,a}, X_{2,b}, X_{2,c} . . . X_{2,i} 25, a second set of shift pointers h_{2,a}, h_{2,b}, h_{2,c} . . . h_{2,i} 26, and a second rearranged defined-distribution table 33. Ultimately the process results in an n^{th} set of elements from a component pseudo-random number generator X_{n,a}, X_{n,b}, X_{n,c} . . . X_{n,i} 35, an n^{th} set of shift pointers h_{n,a}, h_{n,b}, h_{n,c} . . . h_{n,i} 36, an n^{th} rearranged defined-distribution table 43 an n+1^{th} element from a component pseudo-random number generator Yₙ₊₁ 41, an n+1^{th} output pointer jₙ₊₁ 42, and an n+1^{th} selected output element Dⱼₙ₊₁ 44.

In the embodiment shown in FIG. 4, the initialized defined-distribution table 13 consists of a user-specified set of possible output values that have been initialized by the process shown in FIG. 2. In that process, the chosen, specified set of possible output values are loaded into an initial defined-distribution table 111 and rearranged for a specified number of cycles to create the initialized defined-distribution table (13 in FIG. 2). The first element from the component pseudo-random number generator Y₁ 11 is generated by an independent pseudo-random number generator process beneficially consisting of a set of initialization cycles of virtually any type of pseudo-random number generator process established with specified seed values. The first output pointer j₁ 12 may be created from the first element from the component pseudo-random number generator Y₁ 11 using a multiplicative assignment kY₁/m_{y} where m_{y} is the modulus used in the component pseudo-random number generator Y or, more generally, where m_{y} is simply the range of values created by the component pseudo-random number generator Y, k is the number chosen to be smaller than the size of the initialized defined-distribution table 13 and represents the selectable portion of the initialized defined-distribution table 13 and m_{y} should ideally satisfy the condition that m_{y} is equal to or greater than k. Alternatively, the first output pointer j₁ 12 may be created from the first element from the component pseudo-random number generator Y₁ 11 using a modular reduction assignment Y₁ mod k or from any other process that maps the values of the range of elements of the series Y generated by the component pseudo-random number generator onto the range k of the selectable portion of the initialized defined-distribution table 13. The first output element Dⱼ₁ 14 of the DDES pseudo-random number generator system of the claimed invention is the element of the initialized defined-distribution table 13 selected by the first output pointer j₁ 12. The first set of elements from the component pseudo-random number generator X_{1,a}, X_{1,b}, X_{1,c} . . . X_{1,i} 15 is generated by an independent pseudo-random number generator process conveniently consisting of a set of initialization cycles of virtually any type of pseudo-random number generator process established with specified seed values. The first set of shift pointers h_{1,a}, h_{1,b}, h_{1,c} . . . h_{1,i} 16 may be created from the first set of elements from the component pseudo-random number generator X_{1,a}, X_{1,b}, X_{1,c} . . . X_{1,i} 15 using a multiplicative assignment (k+z)[X_{1,a}, X_{1,b}, X_{1,c} . . . X_{1,i}]/mₓ where mₓ is the modulus used in the component pseudo-random number generator X or, more generally, where mₓ is simply the range of values created by the component pseudo-random number generator X, z is the number chosen such that (k+z) is the size of the entire initialized defined-distribution table 13 and mₓ should ideally satisfy the condition that mₓ is equal to or greater than (k+z). Alternatively, the first set of shift pointers h_{1,a}, h_{1,b}, h_{1,c} . . . h_{1,i} 16 may be created from the first set of elements from the component pseudo-random number generator X_{1,a}, X_{1,b}, X_{1,c} . . . X_{1,i} 15 using a modular reduction assignment [X_{1,a}, X_{1,b}, X_{1,c} . . . X_{1,i}] mod (k+z) or from any other process that maps the values of the range of elements of the series X generated by the component pseudo-random number generator onto the range (k+z) of the entire initialized defined-distribution table 13. The first rearranged defined-distribution table 23 is created from the initialized defined-distribution table 13 by switching the positions of elements in the initialized defined-distribution table 13 using the first set of shift pointers h_{1,a}, h_{1,b}, h_{1,c} . . . h_{1,i} 16 separately from or in conjunction with the first output pointer j₁ 12 created from the first element from the component pseudo-random number generator Y₁ 11.

For the embodiment shown in FIG. 4, the rearranged defined-distribution table 23 created from the first cycle of the pseudo-random number generator system of the claimed invention consists of the same specified set of possible output values that had been present in the initialized defined-distribution table 13. The second element from the component pseudo-random number generator Y₂ 21 is generated by the next cycle of the independent pseudo-random number generator process Y. The second output pointer j₂ 22 can beneficially be created from the second element from the component pseudo-random number generator Y₂ 21 using a multiplicative assignment, modular reduction assignment or other mapping assignment process from the range of elements of the series Y generated by the component pseudo-random number generator onto the range k of the selectable portion of the rearranged defined-distribution table 23. The second output element Dⱼ₂ 24 of the DDES pseudo-random number generator system of the claimed invention is the element of the rearranged defined-distribution table 23 selected by the second output pointer j₂ 22. The second set of elements from the component pseudo-random number generator X_{2,a}, X_{2,b}, X_{2,c} . . . X_{2,i} 25 is generated by the next cycle of the independent pseudo-random number generator process X. The second set of shift pointers h_{2,a}, h_{2,b}, h_{2,c} . . . h_{2,i} 26 can advantageously be created from the second set of elements from the component pseudo-random number generator X_{2,a}, X_{2,b}, X_{2,c} . . . X_{2,i} 25 using a multiplicative assignment, modular reduction assignment or other mapping assignment process from the range of elements of the series X generated by the component pseudo-random number generator onto the range (k+z) of the entire rearranged defined-distribution table 23. The second rearranged defined-distribution table 33 is created from the first rearranged defined-distribution table 23 by switching the positions of elements in the first rearranged defined-distribution table 23 using the second set of shift pointers h_{2,a}, h_{2,b}, h_{2,c} . . . h_{2,i} 26 separately from or in conjunction with the second output pointer j₂ 22 created from the second element from the component pseudo-random number generator Y₂ 21.

Subsequent cycles of operation of the embodiment of the pseudo-random number generator system of the claimed invention as shown in FIG. 4 are shown as the n+1^{th} cycle where the n^{th} rearranged defined-distribution table 43 is created from the prior rearranged defined-distribution table using the n^{th} set of elements from the component pseudo-random number generator X_{n,a}, X_{n,b}, X_{n,c} . . . X_{n,i} 35 to create the resulting n^{th} set of shift pointers h_{n,a}, h_{n,b}, h_{n,c} . . . h_{n,i} 36 separately from or in conjunction with the n^{th} output pointer jₙ (not shown) created from the n^{th} element from the component pseudo-random number generator Yₙ (not shown), by rearranging the positions of elements in the n−1^{th} rearranged defined-distribution table. The n+1^{th} element from the component pseudo-random number generator Yₙ₊₁ 41 is generated by the next cycle of the independent pseudo-random number generator process Y from which the n+1^{th} output pointer jₙ₊₁ 42 is created. The n+1^{th} output element Dⱼₙ₊₁ 44 of the DDES pseudo-random number generator system of the claimed invention is the element of the n^{th} rearranged defined-distribution table 43 selected by the n+1^{th} output pointer jₙ₊₁ 42. In this manner, a series of pseudo-random numbers Dⱼ₁ 14, Dⱼ₂ 24, . . . Dⱼₙ₊₁ 44 is generated.

Another alternative embodiment of the defined-distribution expanded shuffling (DDES) pseudo-random number generator system of the claimed invention as shown in FIG. 4 uses sequential elements from a set of distinct component pseudo-random number generators instead of sequential sets of elements from a single component pseudo-random number generator. This alternative embodiment uses i separate first elements X_{1,a}, X_{1,b}, X_{1,c} . . . X_{1,i} 15 from distinct component pseudo-random number generators Xₐ, X_{b}, X_{c} . . . Xᵢ to generate the first set of shift pointers h_{1,a}, h_{1,b}, h_{1,c} . . . h_{1,i} 16, the second set of shift pointers h_{2,a}, h_{2,b}, h_{2,c} . . . h_{2,i} 26 being generated from the second elements X_{2,a}, X_{2,b}, X_{2,c} . . . X_{2,i} 25 from the component pseudo-random number generators Xₐ, X_{b}, X_{c} . . . Xᵢ, and the n^{th} set of shift pointers h_{n,a}, h_{n,b}, h_{n,c} . . . h_{n,i} 36 being generated from the n^{th} elements X_{n,a}, X_{n,b}, X_{n,c} . . . X_{n,i} 35 from the component pseudo-random number generators Xₐ, X_{b}, X_{c} . . . Xᵢ.

FIG. 5 shows an alternative embodiment of the defined-distribution expanded shuffling (DDES) pseudo-random number generator system of the claimed invention that incorporates an initialized defined-distribution table 13, a first element from a component pseudo-random number generator Y₁ 11, a first output pointer j₁ 12, a selected first output element Dⱼ₁ 14, a first set of prior elements Y_{1,a}, Y_{1,b}, Y_{1,c} . . . Y_{1,i} 17 from the same component pseudo-random number generator Y, a first set of shift pointers h_{1,a}, h_{1,b}, h_{1,c} . . . h_{1,i} 18, and a first rearranged defined-distribution table 23. Generation of subsequent rounds of output elements are represented by a second element from a component pseudo-random number generator Y₂ 21, a second output pointer j₂ 22, a selected second output element Dⱼ₂ 24, a second set of prior elements Y_{2,a}, Y_{2,b}, Y_{2,c} . . . Y_{2,i} 27 from the same component pseudo-random number generator Y, a second set of shift pointers h_{2,a}, h_{2,b}, h_{2,c} . . . h_{2,i} 28, and a second rearranged defined-distribution table 33. Ultimately, the process results in an n^{th} set of prior elements Y_{n,a}, Y_{n,b}, Y_{n,c} . . . Y_{n,i} 37 from the same component pseudo-random number generator Y, an n^{th} set of shift pointers h_{n,a}, h_{n b}, h_{n,c} . . . h_{n,i} 38, an n^{th} rearranged defined-distribution table 43, an n+1^{th} element from a component pseudo-random number generator Yₙ₊₁ 41, an n+1^{th} output pointer jₙ₊₁ 42, and an n+1^{th} selected output element Dⱼₙ₊₁ 44.

In the embodiment shown in FIG. 5, the initialized defined-distribution table 13 consists of a user-specified set of possible output values that have been initialized by the process shown in FIG. 2. In that process, the chosen, specified set of possible output values are loaded into an initial defined-distribution table 111 and rearranged for a specified number of cycles to create the initialized defined-distribution table (13 in FIG. 2). The first element from the component pseudo-random number generator Y₁ 11 is generated by an independent pseudo-random number generator process beneficially consisting of a set of initialization cycles of virtually any type of pseudo-random number generator process established with specified seed values. In addition, sets of prior elements from the same component pseudo-random number generator Y are retained where Y_{1,a}=Y₁₋ₜₐ, Y_{1,b}=Y_{1-tb}, Y_{1,c}=Y_{1-tc} . . . Y_{1,i}=Y₁₋ₜᵢ; Y_{2,a}=Y₂₋ₜₐ, Y_{2,b}=Y_{2-tb}, Y_{2,c}=Y_{2-tc} . . . Y_{2,i}=Y_{2-ti; Y}_{1,a}=Yₙ₋ₜₐ, Y_{n,b}=Y_{n-tb}, Y_{n,c}=Y_{n-tc} . . . Y_{n,i}=Yₙ₋ₜᵢ and 1-ta, 1-tb, 1-tc, 1-ti and, in general, n-ta, n-tb, n-tc and n-ti are prior generation cycle indices that refer to prior elements from the same component pseudo-random number generator Y.

The first output pointer j₁ 12 may be created from the first current element from the component pseudo-random number generator Y₁ 11 using a multiplicative assignment kY₁/m_{y} where m_{y} is the modulus used in the component pseudo-random number generator Y or, more generally, where m_{y} is simply the range of values created by the component pseudo-random number generator Y, k is the number chosen to be smaller than the size of the initialized defined-distribution table 13 and represents the selectable portion of the initialized defined-distribution table 13 and m_{y} should ideally satisfy a condition specified below. Alternatively, the first output pointer j₁ 12 may be created from the first current element from the component pseudo-random number generator Y₁ 11 using a modular reduction assignment Y₁ mod k or from any other process that maps the values of the range of elements of the series Y generated by the component pseudo-random number generator onto the range k of the selectable portion of the initialized defined-distribution table 13. The first output element Dⱼ₁ 14 of the DDES pseudo-random number generator system of the claimed invention is the element of the initialized defined-distribution table 13 selected by the first output pointer j₁ 12. The first set of shift pointers h_{1,a}, h_{1,b}, h_{1,c} . . . h_{1,i} 18 may be created from the first set of retained prior elements Y_{1,a}, Y_{1,b}, Y_{1,c} . . . Y_{1,i} 17 from the same component pseudo-random number generator Y using a multiplicative assignment (k+z)[Y_{1,a}, Y_{1,b}, Y_{1,c} . . . Y_{1,i}]/m_{y} where m_{y} is the modulus used in the component pseudo-random number generator Y or, more generally, where m_{y} is simply the range of values created by the component pseudo-random number generator Y, z is the number chosen such that (k+z) is the size of the entire initialized defined-distribution table 13 and m_{y} should ideally satisfy the condition that m_{y} is equal to or greater than (k+z). Alternatively, the first set of shift pointers h_{1,a}, h_{1,b}, h_{1,c} . . . h_{1,i} 18 is created from the first set of retained prior elements Y_{1,a}, Y_{1,b}, Y_{1,c} . . . Y_{1,i} 17 from the same component pseudo-random number generator Y using a modular reduction assignment [Y_{1,a}, Y_{1,b}, Y_{1,c} . . . Y_{1,i}] mod (k+z) or from any other process that maps the values of the range of elements of the series Y generated by the component pseudo-random number generator onto the range (k+z) of the entire initialized defined-distribution table 13. In the embodiment shown in FIG. 5, the first rearranged defined-distribution table 23 is created from the initialized defined-distribution table 13 by switching the positions of elements in the initialized defined-distribution table 13 using the first set of shift pointers h_{1,a}, h_{1,b}, h_{1,c} . . . h_{1,i} 18 separately from or in conjunction with the first output pointer j₁ 12 created from the first current element Y₁ 11 from the component pseudo-random number generator Y.

For the embodiment shown in FIG. 5, the rearranged defined-distribution table 23 created from the first cycle of the pseudo-random number generator system of the claimed invention consists of the same specified set of possible output values that had been present in the initialized defined-distribution table 13. The component pseudo-random number generator Y is used to generate the second element from the component pseudo-random number generator Y₂ 21. The second current element from the component pseudo-random number generator Y₂ 21 is generated by the next cycle of the independent pseudo-random number generator process Y. The second output pointer j₂ 22 can be conveniently created from the second current element from the component pseudo-random number generator Y₂ 21 using a multiplicative assignment, modular reduction assignment or other mapping assignment process from the range of elements of the series Y generated by the component pseudo-random number generator onto the range k of the selectable portion of the rearranged defined-distribution table 23. The second output element Dⱼ₂ 24 of the DDES pseudo-random number generator system of the claimed invention is the element of the rearranged defined-distribution table 23 selected by the second output pointer j₂ 22. The second set of shift pointers h_{2,a}, h_{2,b}, h_{2,c} . . . h_{2,i} 28 can be generated from the second set of retained prior elements Y_{2,a}, Y_{2,b}, Y_{2,c} . . . Y_{2,i} 27 from the same component pseudo-random number generator Y using a multiplicative assignment, modular reduction assignment or other mapping assignment process from the range of elements of the series Y generated by the component pseudo-random number generator onto the range (k+z) of the entire rearranged defined-distribution table 23. The second rearranged defined-distribution table 33 is created from the first rearranged defined-distribution table 23 by switching the positions of elements in the first rearranged defined-distribution table 23 using the second set of shift pointers h_{2,a}, h_{2,b}, h_{2,c} . . . h_{2,i} 28 separately from or in conjunction with the second output pointer j₂ 22 created from the second current element Y₂ 21 from the component pseudo-random number generator Y.

Subsequent cycles of operation of the embodiment of the pseudo-random number generator system of the claimed invention as shown in FIG. 5 are represented by the n+1^{th} cycle where the n^{th} rearranged defined-distribution table 43 is created from the prior rearranged defined-distribution table using the n^{th} set of retained prior elements Y_{n,a}, Y_{n,b}, Y_{n,c} . . . Y_{n,i} 37 from the same component pseudo-random number generator Y to create the resulting n^{th} set of shift pointers h_{n,a}, h_{n,b}, h_{n,c} . . . h_{n,i} 38 separately from or in conjunction with the n^{th} output pointer jₙ (not shown) created from the n^{th} current element from the component pseudo-random number generator Yₙ (not shown), by rearranging the positions of elements in the n−1^{th} rearranged defined-distribution table. The n+1^{th} element from the component pseudo-random number generator Yₙ₊₁ 41 is generated by the next cycle of the independent pseudo-random number generator process Y from which the n+1^{th} output pointer jₙ₊₁ 42 is created. The n+1^{th} output element Dⱼₙ₊₁ 44 of the DDES pseudo-random number generator system of the claimed invention is the element of the n^{th} rearranged defined-distribution table 43 selected by the n+1^{th} output pointer Jₙ₊₁ 42. In this manner, a series of pseudo-random numbers Dⱼ₁ 14, Dⱼ₂ 24, . . . Dⱼₙ₊₁ 44 is generated.

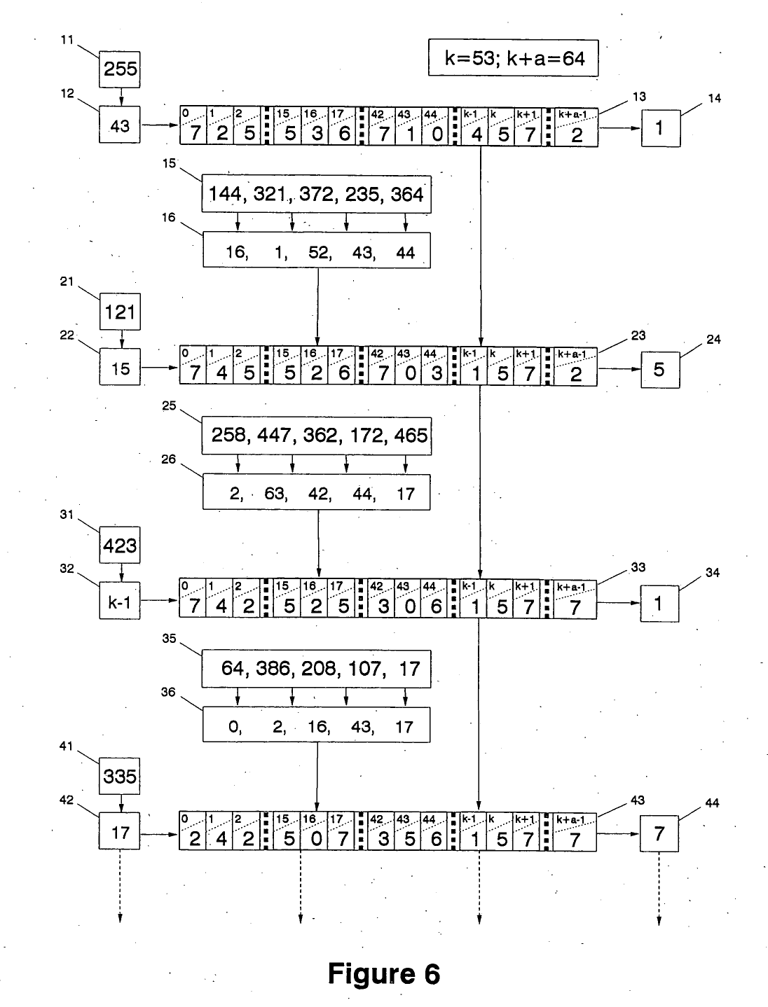

In FIG. 6, an example demonstrates the sequential operation of the functional components of the alternative embodiment of the defined-distribution expanded shuffling (DDES) pseudo-random number generator system of the claimed invention for the embodiment that is shown in FIG. 4. The example of FIG. 6 incorporates single output pointers [43, 15, k−1, 17] 12, 22, 32, 42 created from specified initial elements [255, 121, 423, 335] 11, 21, 31, 41 generated by a component pseudo-random number generator Y, multiple shift pointers [16, 1, 52, 43, 44; 2, 63, 42, 44, 17; 0, 2, 16, 43, 17] 16, 26, 36 created from from specified initial elements [144, 321, 372, 235, 364; 258, 447, 362, 172, 465; 64, 386, 208, 107, 17] 15, 25, 35 generated by a component pseudo-random number generator X, and an initialized defined-distribution table 13 containing (k+z) elements over the uniform range of 8 values from 0 to 7 with k being set to 53; (k+z) being set to 64; the 0^{th}, 1^{st} and 2^{nd} elements being 7, 2 and 5; the 15^{th}, 16^{th} and 17^{th} elements being 5, 3 and 6; the 42^{nd}, 43^{nd} and 44^{th} elements being 7, 1 and 0; the k−1^{th}, k^{th} and k+1^{th} elements being 4, 5 and 7; and the (k+z−1)^{th} element being 2. Note that the initialized defined-distribution table 13 contains p=8 values in a full representation of the desired uniform distribution and that z is chosen to be 11 satisfying the condition that (k+z) mod p≡0. Further note that the range of elements of the component pseudo-random number generator Y, m_{y}=424, satisfies the condition that m_{y} is equal to or greater than k since 424≦53 and that the range of elements of the component pseudo-random number generator X, mₓ=465, satisfies the condition that mₓ is equal to or greater than (k+z) since 465≦64. Output pointers j 12, 22, 32, 42 were created using a modular reduction assignment Y mod k where k=53 and shift pointers h 16, 26, 36 were created using a modular reduction assignment [Xₐ, X_{b}, X_{c} . . . Xᵢ] mod (k+z) where (k+z)=64. The example shown in FIG. 6 incorporates an initialized defined-distribution table 13, a first element from a component pseudo-random number generator Y with a value of [255] 11, a first output pointer with a value of [43] 12, a selected first output element with a value of [1] 14, a first set of elements from a component pseudo-random number generator X with values of [144, 321, 372, 235, 364] 15, a first set of shift pointers with values of [16, 1, 52, 43, 44] 16, and a first rearranged defined-distribution table 23. Generation of subsequent rounds of output elements are represented by a second element from a component pseudo-random number generator Y with a value of [121] 21, a second output pointer with a value of [15] 22, a selected second output element with a value of [5] 24, a second set of elements from a component pseudo-random number generator X with values of [258, 447, 362, 172, 465] 25, a second set of shift pointers with values of [2, 63, 42, 44, 17] 26, and a second rearranged defined-distribution table 33; a third element from a component pseudo-random number generator Y with a value of [423] 31, a third output pointer with a value of [k−1 (i.e., 52)] 32, a selected third output element with a value of [1] 34 , a third set of elements from a component pseudo-random number generator X with values of [64, 386, 208, 107, 17] 35, a third set of shift pointers with values of [0, 2, 16, 43, 17] 36, and a third rearranged defined-distribution table 43; and a fourth element from a component pseudo-random number generator Y with a value of [335] 41, a fourth output pointer with a value of [17] 42, a selected fourth output element with a value of [7] 44, etc.

In the example of the embodiment shown in FIG. 6, the initialized defined-distribution table 13 consists of a user-specified set of 8 possible output values over the range of 0 to 7 uniformly distributed with 8 copies of each output value loaded into an initial defined-distribution table of 64 elements and rearranged for a specified number of cycles resulting in the sample values shown. The component pseudo-random number generator Y consists of an independent pseudo-random number generator process yielding the first element value of [255] 11. The first output pointer value of [43] 12 is created from the first element from the component pseudo-random number generator [255] 11 using a modular reduction assignment [255] mod 53. The first output element value of [1] 14 is found as the value of the initialized defined-distribution table 13 associated with the location pointer of [43] 12. The component pseudo-random number generator X consists of an independent pseudo-random number generator process yielding the first set of element values of [144, 321, 372, 235, 364] 15. The first set of shift pointer values of [16, 1, 52, 43, 44] 16 is created from the first set of elements from the component pseudo-random number generator X [144, 321, 372, 235, 364] 15 using a modular reduction assignment [144, 321, 372, 235, 364] mod 64. The first rearranged defined-distribution table 23 is created from the initialized defined-distribution table 13 by switching the positions of elements in the initialized defined-distribution table 13 using the first set of shift pointers [16, 1, 52, 43, 44] 16, that is, D[temp]←D[16], D[16]←D[1], D[1]←D[52], D[52]←D[43], D[43]←D[44], D[44]←D[temp] which results in the shifting of values as D[temp]←[3], D[16]←[2], D[1]←[4], D[52]←[1], D[43]←[0], D[44]←+[3], where D represents the defined-distribution table 13 and D[h] represents the value of the defined-distribution table for location pointer h 16.

For the example of the embodiment shown in FIG. 6, the rearranged defined-distribution table 23 created from the first cycle of the pseudo-random number generator system of the claimed invention consists of the same specified set of possible output values that had been loaded into an initial defined-distribution table 111 of FIG. 2 and following the procedure described for FIG. 2 resulted in an initialized defined-distribution table 13 in FIG. 2. For the second cycle of the example of pseudo-random number generator system, the component pseudo-random number generator Y yields the second element value of [121] 21. The second output pointer value of [15] 22 is created using a modular reduction assignment [121] mod 53. The second output element value of [5] 24 is found as the value of the rearranged defined-distribution table 23 associated with the location pointer of [15] 22. The component pseudo-random number generator X yields the second set of element values of [258, 447, 362, 172, 465] 25. The second set of shift pointer values of [2, 63, 42, 44, 17] 26 is created using a modular reduction assignment [258, 447, 362, 172, 465] mod 64. The second rearranged defined-distribution table 33 is created from the rearranged defined-distribution table 23 by switching the positions of elements D[temp]←D[2], D[2]←D[63], D[63]←D[42], D[42]←D[44], D[44]←D[17], D[17]←D[temp] which results in the shifting of values as D[temp]←[5], D[2]←[2], D[63]←[7], D[42]←[3], D[44]←[6], D[17]←[5].

For the third cycle of the example of the pseudo-random number generator system shown in FIG. 6, Y yields the third element value of [423] 31; the third output pointer value is [k−1 (i.e., 52)] 32 (from 423 mod 53); the third output element value of [1] 34 is found from the rearranged defined-distribution table 33 using the location pointer of [k−1]; X yields the third set of element values of [64, 386, 208, 107, 17] 35; the third set of shift pointer values is [0, 2, 16, 43, 17] 36 (from [64, 386, 208, 107, 17] mod 64); the third rearranged defined-distribution table 43 is created from the rearranged defined-distribution table 33 by switching the positions of elements D[temp]←D[0], D[0]←D[2], D[2]←D[16], D[16]←D[43], D[43]←, D[17], D[17]←D[temp] or D[temp]←[7], D[0]←[2], D[2]←[2], D[16]←[0], D[43]←[5], D[17]←[7].

The beginning of the fourth cycle of the example shown in FIG. 6 shows Y with a fourth element value of [335] 41; the fourth output pointer value of [17] 42 (from 335 mod 53); and the fourth output element value of [7] 44 found from the rearranged defined-distribution table 43 using the location pointer of [17] 42.

Subsequent cycles of operation of the example embodiment of the pseudo-random number generator system of the claimed invention as shown in FIG. 6 would use subsequent X values to create shift pointers and rearrange the defined-distribution table. Following Y values would create output pointers that would select output element values from the rearranged defined-distribution table. Ultimately, the example in FIG. 6 yields a series of pseudo random numbers [1, 5, 1, 7 . . . ] 14, 24, 34, 44.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

What is claimed is:

1. A method of generating a pseudo-random number, said method comprising the steps of:
a. Establishing an output value set of all possible desired output values, with each possible desired output value represented only once in the output value set;
b. Transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Establishing a defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create the defined-distribution table;
d. Determining an initial value j₁ for an output pointer j; and
e. Generating a pseudo random number by selecting an element of the defined-distribution table indexed by the output pointer j₁.

2. A method of generating a pseudo-random number according to claim 1, in which values for the output pointer j are established by a component pseudo-random number generator Y.

3. A method of generating a pseudo-random number according to claim 2, in which values for the output pointer j are established from a value Yₙ generated by the component pseudo-random number generator Y using mathematical assignment from Yₙ onto a range k which comprises a selectable portion of the defined-distribution table.

4. A method of generating a pseudo-random number according to claim 2, in which values for the output pointer j are established from a value Yₙ generated by the component pseudo-random number generator using a mapping assignment process from Yₙ onto a range k which comprises a selectable portion of the defined-distribution table.

5. A method of generating a pseudo-random number according to claim 1, further comprising the steps of:
a. Initializing said defined-distribution table by:
i. selecting a number of initialization shuffling cycles to be executed,
ii. utilizing a component pseudo-random number generator X to 17 create values Xₐ-Xᵢ,
iii. determining values hₐ-hᵢ for a shift pointer h from said values Xₐ-Xᵢ,
iv. establishing a rearranged defined-distribution table by shuffling elements of the defined-distribution table using the shift pointers hₐ-hᵢ, and
v. repeating steps ii. through iv. for the selected number of initialization shuffling cycles to establish an initialized defined-distribution table; and
b. Utilizing said initialized defined-distribution table to generate the pseudo-random number by selecting an element of said initialized defined-distribution table indexed by the output pointer jₗ.

6. A method of generating a pseudo-random number according to claim 5, in 31 which values for the shift pointer h are established from a value Xₙ generated by the component pseudo-random number generator X using mathematical assignment from Xₙ onto a range (k+z) which comprises the defined-distribution table.

7. A method of generating a pseudo-random number according to claim 5, in which values for the shift pointer h are established from a value Xₙ generated by the component pseudo-random number generator X using a mapping assignment process from Xₙ onto a range (k+z) which comprises the defined-distribution table.

8. A method of generating a plurality of pseudo-random numbers, said method comprising the steps of:
a. Establishing an output value set of all possible desired output values, with each possible desired output value represented only once in the output value set;
b. Transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Establishing a first defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create said first defined-distribution table;
d. Determining an initial value j₁ for an output pointer j;
e. Generating a pseudo-random number by selecting an element of said first defined-distribution table indexed by the first output pointer j₁;
f. Utilizing a component pseudo-random number generator X to create values X_{1,a}-X_{1,i};
g. Determining values h_{1,a}-h_{1,i} for shift pointer h from said values X_{1,a}-X_{1,i};
h. Establishing a rearranged defined-distribution table by shuffling elements of the first defined-distribution table using the shift pointers h_{1,a}-h_{1,i};
i. Determining a next value j₂ for said output pointer j;
j Generating a next pseudo-random number by selecting an element of the rearranged defined-distribution table indexed by the next output pointer j₂;
k. Utilizing said component pseudo-random number generator X to create next values X_{2,a}-X_{2,i};
l. Determining next values h_{2,a}-h_{2,i} for shift pointer h from the next values X_{2,a}-X_{2,i};
m. Establishing a newly rearranged defined-distribution table by shuffling elements of the prior rearranged defined-distribution table using shift pointers h_{2,a}-h_{2,i}; and
n. Repeating steps i. through m. to generate a desired number of pseudo-random numbers.

9. A method of generating a plurality of pseudo-random numbers according to claim 8, in which values for the output pointer j are established by a component pseudo-random number generator Y.

10. A method of generating a plurality of pseudo-random numbers according to claim 9, in which values for the output pointer j are established from a value Yₙ generated by the component pseudo-random number generator Y using mathematical assignment from Yₙ onto a range k which comprises a selectable portion of the defined-distribution table.

11. A method of generating a plurality of pseudo-random numbers according to claim 9, in which values for the output pointer j are established from a value Yₙ generated by the component pseudo-random number generator Y using a mapping assignment process from Yₙ onto a range k which comprises a selectable portion of the defined-distribution table.

12. A method of generating a plurality of pseudo-random numbers according to claim 8, further comprising the steps of:
a. Initializing said first defined-distribution table by:
i. selecting a number of initialization shuffling cycles to be executed,
ii. utilizing a component pseudo-random number generator X to create values Xₐ-Xᵢ,
iii. determining values hₐ-hᵢ for a shift pointer h from said values Xₐ-Xᵢ,
iv. establishing a rearranged first defined-distribution table by shuffling elements of the first defined-distribution table using the shift pointers hₐ-hᵢ, and
v. repeating steps ii. through iv. for the selected number of initialization shuffling cycles to establish an initialized first defined-distribution table; and
b. Utilizing said initialized first defined-distribution table to generate a first pseudo-random number by selecting an element of said initialized first defined-distribution table indexed by the output pointer j₁.

13. A method of generating a plurality of pseudo-random numbers according to claim 12, in which values for the shift pointer h are established from a value Xₙ generated by the component pseudo-random number generator X using mathematical assignment from Xₙ onto a range (k+z) which comprises the defined-distribution table.

14. A method of generating a pseudo-random number according to claim 12, in which values for the shift pointer h are established from a value Xₙ generated by the component pseudo-random number generator X using a mapping assignment process from Xₙ onto a range (k+z) which comprises the defined-distribution table.

15. A method of generating a plurality of pseudo-random numbers, said method comprising the steps of:
a. Establishing an output value set of all possible desired output values, with each possible desired output value represented only once in the output value set;
b. Transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Establishing a first defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create said first defined-distribution table;
d. Determining an initial value j₁ for an output pointer j;
e. Generating a pseudo-random number by selecting an element of said first defined-distribution table indexed by the first output pointer j₁;
f. Utilizing a component pseudo-random number generator X to create value X₁;
g. Determining an initial value h₁ for shift pointer h from said value X₁;
h. Establishing a rearranged defined-distribution table by shuffling elements of the first defined-distribution table using the shift pointers h₁ and the output pointer j₁;
i. Determining a next value j₂ for said output pointer j;
j. Generating a next pseudo-random number by selecting an element of the rearranged defined-distribution table indexed by the next output pointer j₂;
k. Utilizing said component pseudo-random number generator X to create next value X₂;
l. Determining next value h₂ for shift pointer h from the next value X₂;
m. Establishing a newly rearranged defined-distribution table by shuffling elements of the prior rearranged defined-distribution table using shift pointer h₂ and output pointer j₂; and
n. Repeating steps i. through m. to generate a desired number of pseudo-random numbers.

16. A method according to claim 15, in which values for the shift pointer h are established from a value Xₙ generated by the component pseudo-random number generator X using mathematical assignment from Xₙ onto a range (k+z) which comprises the defined-distribution table.

17. A method according to claim 15, in which values for the shift pointer h are established from a value Xₙ generated by the component pseudo-random number generator X using mapping assignment process from Xₙ onto a range (k+z) which comprises the defined-distribution table.

18. A method of generating a plurality of pseudo-random numbers, said method comprising the steps of:
a. Establishing an output value set of all possible desired output values, with each possible desired output value represented only once in the output value set;
b. Transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Establishing a first defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create said first defined-distribution table;
d. Establishing a sequence of initial values for an output series of pseudo-random number sequence Y;
e. Establishing an initial selector value Y₁ from the sequence of initial values for the output series of the pseudo-random number sequence Y;
f. Establishing initial shift values Y_{1,a}-Y_{1,i} from the sequence of initial values for the output series of the pseudo-random number sequence Y;
g. Determining an initial value j₁ for an output pointer j from the initial selector value Y₁;
h. Generating a pseudo-random number by selecting an element of said first defined-distribution table indexed by the first output pointer j₁;
i. Determining initial values h_{1,a}-h_{1,i} for shift pointer h from said initial shift values Y_{1,a}-Y_{1,i};
j. Establishing a rearranged defined-distribution table by shuffling elements of the first defined-distribution table using initial values h_{1,a}-h_{1,i} for the shift pointers h;
k. Establishing a next sequence of values for an output series of pseudo-random number sequence Y;
l. Establishing a next selector value Y₂ from the next sequence of values for the output series of the pseudo-random number sequence Y;
m. Establishing next shift values Y_{2,a}-Y_{2,i} from the next sequence of values for the output series of the pseudo-random number sequence Y;
n. Determining a next value j₂ for the output pointer j from the next selector value Y₂;
o. Generating a next pseudo-random number by selecting an element of the rearranged defined-distribution table indexed by the next output pointer j₂;
p. Determining next values h_{2,a}-h_{2,i} for shift pointer h from the next shift values Y_{2,a}-Y_{2,i};
q. Establishing a newly rearranged defined-distribution table by shuffling elements of the prior rearranged defined-distribution table using values h_{2,a}-h_{2,i} for shift pointer h; and
r. Repeating steps k. through q. to generate a desired number of pseudo-random numbers.

19. A method according to claim 18, in which values for the output pointer j are established from the selector values Yₙ of the pseudo-random number sequence Y using mathematical assignment from the range of elements of the sequence Y onto a range k of a selectable portion of the defined-distribution table.

20. A method according to claim 18, in which values for the output pointer j are established from the selector values Yₙ of the pseudo-random number sequence Y using a mapping assignment process from the range of elements of the sequence Y onto a range k of a selectable portion of the defined-distribution table.

21. A method according to claim 18, in which values for the shift pointers hₐ-hᵢ are established from the shift values Yₐ-Yᵢ generated by the component pseudo-random number generator Y using mathematical assignment from the range of elements of the sequence Y onto a range (k+z) which comprises the defined-distribution table.

22. A method according to claim 18, in which values for the shift pointers hₐ-hᵢ are established from the shift values Yₐ-Yᵢ generated by the component pseudo-random number generator Y using a mapping assignment process from the range of elements of the sequence Y onto a range (k+z) which comprises the defined-distribution table.

23. A method according to claim 8, further comprising the step of selecting a subset of said pseudo-random numbers from said output series of pseudo-random numbers.

24. An apparatus for generating a pseudo-random number, comprising:
a. Output value means for establishing an output value set of all possible desired output values, with each possible desired output value represented only once in the output value set;
b. Distribution set means for transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Defined distribution table means for establishing a defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create the defined-distribution table;
d. Output pointer means for determining an initial value j₁ for an output pointer j; and
e. Pseudo random number means for generating a pseudo random number by selecting an element of the defined-distribution table indexed by the output pointer j₁.

25. An apparatus for generating a plurality of pseudo-random numbers, comprising:
a. Output value means for establishing an output value set of all possible desired output values, with each possible desired output value represented only once in the output value set;
b. Distribution set means for transforming the output value set into a plurality of distribution sets, each distribution set having all possible desired output values, with each possible desired output value occurring in each distribution set with respect to all other values in that distribution set a number of times corresponding to a relative desired distribution for that desired output value in a final set of desired output values, and with each distribution set having p total elements;
c. Defined-distribution table means for establishing a first defined-distribution table containing (k+z) elements by:
i. setting a variable k to be a value greater than or equal to the total number of elements p of each distribution set,
ii. setting a variable z to be a value greater than or equal to 0 and satisfying the condition that (k+z) mod p is congruent to 0, and
iii. loading (k+z)/p multiple distribution sets into a table to create said first defined-distribution table;
d. Output pointer means for determining an initial value j₁ for an output pointer j;
e. Pseudo-random number means for generating a pseudo-random number by selecting an element of said first defined-distribution table indexed by the first output pointer j₁;
f. Component means for utilizing a component pseudo-random number generator X to create values Xₐ-Xᵢ;
g. Shift pointer means for determining values hₐ-hᵢ for shift pointer h from said values Xₐ-Xᵢ;
h. Rearranged table means for establishing a rearranged defined-distribution table by shuffling elements of the first defined-distribution table using the shift pointers hₐ-hᵢ;
i. Updating output pointer means for determining a next value j₂ for said output pointer j;
j. Next pseudo-random number means for generating a next pseudo-random number by selecting an element of the rearranged defined-distribution table indexed by the next output pointer j₂;
k. Updating component means for utilizing said component pseudo-random number generator X to create next values X₂ₐ-X_{2,i};
l. Updating shift pointer means for determining next values h_{2,a}-h_{2,i} for shift pointer h from the next values X_{2,a}-X_{2,i};
m. Newly rearranged table means for establishing a newly rearranged defined-distribution table by shuffling elements of the prior rearranged defined-distribution table using shift pointers h_{2,a}-h_{2,i}; and
n. Repetitive means for sequentially utilizing the rearranged table means, the updated outpoint pointer means, the next pseudo-random number means, the updating component means, the updating shift pointer means, and the newly rearranged table means to generate a desired number of pseudo-random numbers.
